(19) United States
(12) Patent Application Publication
(10) Pub. No.: US 2016/0137227 A1
(43) Pub. Date: May 19, 2016

(54) FRONT SIDE MEMBER FOR VEHICLE

(71) Applicant: HYUNDAI MOTOR COMPANY, Seoul (KR)

(72) Inventors: Do Hoi KIM, Anyang-si (KR); Jin Hak LIM, Seongnam-si (KR); Chan Young KANG, Gunpo-si (KR); Hae Woong KIM, Seoul (KR)

(21) Appl. No.: 14/712,502

(22) Filed: May 14, 2015

(30) Foreign Application Priority Data
Nov. 18, 2014 (KR) 10-2014-0160891

(51) Int. Cl. B62D 21/04; B62D 21/11

(52) U.S. Cl. CPC B62D 21/04; B62D 21/11

(57) ABSTRACT

A front side member for a vehicle includes a front part mounted to a front lower right side and a front lower left side of the vehicle along a length of the vehicle. A rear part is mounted to a rear lower right side and a rear lower left side of the vehicle. A middle part integrally and continuously connected between the front part and rear part. The middle part includes a curved portion formed in the middle of the middle part.

### CROSS-REFERENCE TO RELATED APPLICATION

This application claims the benefit of priority to Korean Patent Application No. 10-2014-0160891 filed in the Korean Intellectual Property Office on Nov. 18, 2014, the entire content of which is incorporated herein by reference.

### TECHNICAL FIELD

The present disclosure relates to a front side member for a vehicle, and more particularly, to a front side member for a vehicle having a curved portion along the length of the vehicle.

### BACKGROUND

A vehicle comprises a front vehicle body that forms an engine compartment in the front along the length of the vehicle. The front vehicle body includes a front end module mounted to a front side of the engine compartment and equipped with a cooling module, a head lamp, etc. A front fender apron member is mounted to left and right sides of engine compartment and provides a space for vehicle wheels as well as a suspension system. A dashboard is located in the rear of the engine compartment between front seats and the engine compartment. A front side member is extendedly mounted along the length of the vehicle to a front lower side of the engine compartment at left and right sides. A sub-frame supports the suspension system, an engine that is installed in the engine compartment, a transmission, and the like.

FIG. 1 illustrates a conventional vehicle structure as described above, in which h_{COG} represents the center of mass of a vehicle, M_{cabin} represents a moment of inertia of a vehicle body with the center of mass of the vehicle as a center, L_{FR}_{_}_{SUSP} represents a distance from a front suspension to the center of gravity, L_{RR}_{_}_{SUSP} represents a distance from the center of mass to a rear suspension, F_{FR}_{_}_{SUSP} represents an external force applied on the front suspension, F_{RR}_{_}_{SUSP} represents an external force applied on the rear suspension, F_{s/mbr} represents an external force applied to a front side member when the vehicle collides, F_{t/a}_{_}ᵤₚᵣ represents an external force applied to a fender apron upper member when the vehicle collides.

When the vehicle collides with a front obstacle, since the front side member extends farther than the fender apron upper member along the length of the vehicle, an impact is applied to primarily on the front side member as the external force F_{s/mbr} and then applied to on the fender apron upper member as the external force F_{t/a-upr}.

The external impact F_{s/mbr} applied to the front side member generates the moment M_{cabin}=F_{s/mbr}*h_{COG} which rotates the vehicle body in a counterclockwise direction with the center of mass h_{COG}, and the external force F_{FR}_{_}_{SUSP}, which presses the vehicle body from the top to the bottom along the height of the vehicle is applied on the front suspension by the moment M_{cabin}. The external force F_{FR}_{_}_{SUSP}, which lifts up the vehicle body from the bottom to the top along the height of the vehicle, is applied on the rear suspension.

Additionally, the above-described moment M_{cabin} causes sinking, in which a front side of the vehicle and a vibration measuring part D, subside to the ground G as shown with the arrow in FIG. 1. Such a sinking phenomenon deteriorates safety of a passenger, for example, by deteriorating airbag performance when the vehicle collides with the obstacle.

Therefore, it is necessary to improve the vehicle structure in order to enhance the safety of the passenger by reducing the sinking amount when a vehicle collision occurs.

The above information disclosed in this Background section is only for enhancement of understanding of the background of the disclosure, and therefore, it may contain information that does not form the prior art that is already known in this country to a person of ordinary skill in the art.

### SUMMARY

An aspect of the present inventive concept provides a front side member for a vehicle that enhances safety of a passenger by reducing a sinking phenomenon when a vehicle collision occurs.

A front side member for a vehicle according to an exemplary embodiment of the present inventive concept may include a front part mounted to a front lower right side and a front lower left side of the vehicle along the length of the vehicle. A rear part is mounted to a rear lower right side and a rear lower left side of the vehicle. A middle part is integrally and continuously connected between the front part and rear part. The middle part includes a curved portion formed in the middle of the middle part.

The front part may include a front upper part provided at a front upper side of the front side member and extending straightly along the length of the vehicle and a front lower part provided at a front lower side of the front side member and extending straightly along the length of the vehicle.

The middle part may include a middle upper part provided at a middle upper side of the vehicle and extending straightly along the length of the vehicle and a middle lower part provided at a middle lower side of the vehicle. The curved portion may be formed at the middle lower part.

The rear part may include a rear upper part provided at a rear upper side of the vehicle and inclined downwards while extending straightly in the length direction of the vehicle and a rear lower part provided at a rear lower side of the vehicle and inclined downwards while extending straightly along the length of the vehicle.

The middle part may have an engine mount mounted thereon in front of a shock absorber position corresponding part that responds to the shock absorber position of a front suspension. The curved portion of the middle lower part may have the center of mass located between the engine mount and the shock absorber position corresponding

The curve portion may have a circular arc shape.

According to the front side member for a vehicle of the exemplary embodiment of the present inventive concept, each of a front part and a rear part straightly extends, thus enduring the impact energy transferred when a front low speed crash occurs and simultaneously restraining an excessive deformation of the front side member. Additionally, the impact energy is effectively absorbed with being compressively deformed.

The middle part and the rear part which are integrally formed in the front part include an upper part and a lower part, respectively. While the middle upper part straightly extends, the middle lower part have a curved portion, and the rear lower part is inclined downwards. Accordingly, when a vehicle collides with a front obstacle ahead when running at a medium or high speed, the front side member entirely deforms upwards causing the front part of a vehicle body to lift upwards. Thus, safety of a passenger is improved by effectively diminishing a sinking level when the front crash occurs.

In addition, the front side member is bent upwards while being compressed and deformed, thus effectively absorbing and attenuating the impact energy. Accordingly, the impact energy transferred toward a dashboard that is connected to the front side member is attenuated, injury from the crash on the passenger in the rear of the dashboard is effectively attenuated, an airbag is operated properly, and safety is secured.

### BRIEF DESCRIPTION OF THE DRAWINGS

FIG. 1 is a brief modeling drawing illustrating a conventional vehicle body.

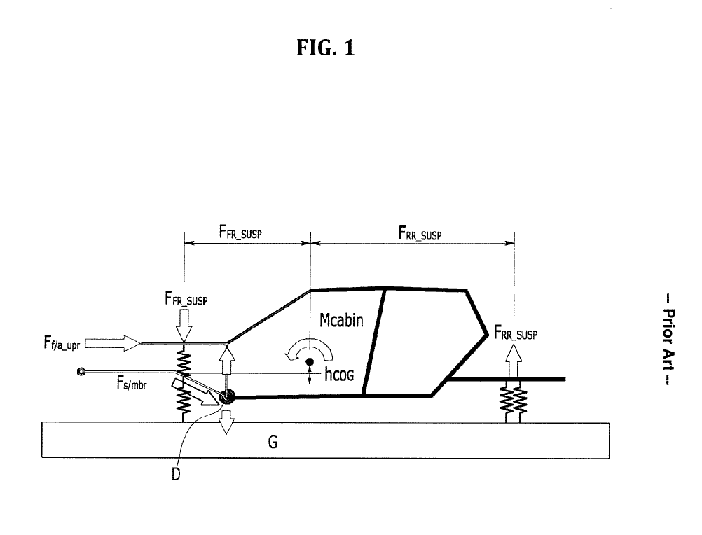

FIG. 2 is a side view of a front side member for a vehicle according to an exemplary embodiment of the present inventive concept.

FIG. 3 is a drawing for describing a collision behavior of a front side member for a vehicle according to an exemplary embodiment of the present inventive concept.

### DETAILED DESCRIPTION OF THE EMBODIMENTS

Herein, an exemplary embodiment of the present inventive concept is described in detail by reference to the exemplary drawings attached.

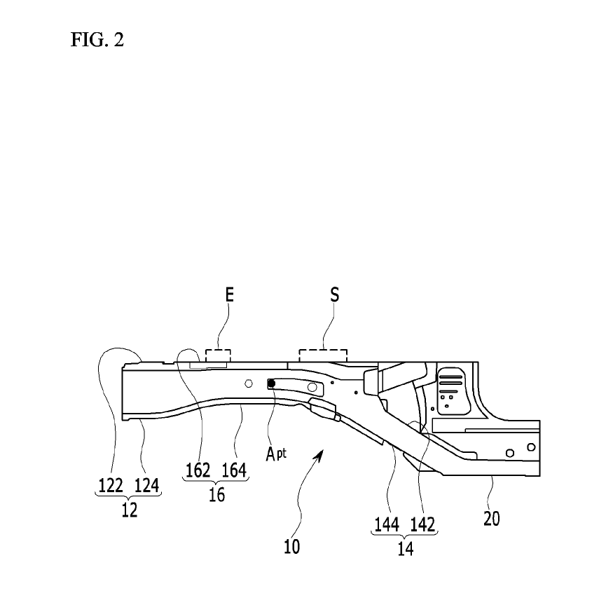

Referring to FIG. 2, a front side member 10 of a vehicle according to the exemplary embodiment of the present inventive concept may extend along the length of the vehicle and mounted at left and right sides along the width of the vehicle.

The front side member 10 may include a front part 12 at the front along the length of the vehicle, a rear part 14 at the rear, and a middle part 16 connected between the rear part 14 and the front part 12.

The front part 12 may include a front upper part 122 provided at a front upper side of the front side member 10 along the length of the vehicle and a front lower part 124 provided at a front lower side of the front side member 10. The front upper part 122 and the front lower part 124 may extend straightly along the length of the vehicle.

Since the front part 12 extends along the length of the vehicle, impact energy generated due to occurrence of a front low speed crash and excessive deformation of the front side member can be reduced. Additionally, the impact energy can be effectively absorbed by compressively deforming the front side member.

The middle part 16 may include a middle upper part 162 provided at a middle upper side of the front side member 10 and a middle lower part 164 provided at a middle lower side of the front side member 10. The middle upper part 162 extends straightly along the length of the vehicle, and the middle lower part 164 may have a curved portion and extend curvedly.

The middle lower part 164 may be curved upward with a predefined curvature, and thus, the middle part 16 may be narrower than the front part 12.

The curved portion may have a circular arc shape.

The middle part 16 may have an engine mount E mounted thereon for fixing an engine.

The engine mount E may be spaced apart from and mounted in front of a shock absorber position corresponding part S which measures a shock absorber position of a front suspension.

Since the curved portion of the middle lower part 164 may have the predefined curvature, the center point Apt is located between the engine mounting part E and the shock absorber position corresponding part S along the length of the curved portion of the middle lower part 164.

During a front crash, impact energy is transferred to the middle part 16, and a middle portion of the middle part 16 including the center of mass Apt primarily causes an upward flexural deformation, and then the front side member 10 deforms upward with the middle part 16. The front side member 10 may not deform due to a heavy weight of the engine mount E and a front-wheel tire and the front suspension may absorb the impact energy before the impact energy is converted into deformation energy by installing a shock absorber at the front-wheel tire. Thus, the center of mass Apt is located between the engine mount E and the shock absorber position corresponding part S.

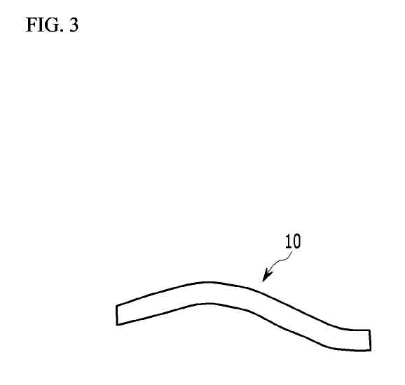

The front side member 10 deforms due to the impact energy when the vehicle collides with an obstacle ahead while running in medium or high speed since the middle part 16 have the circular arc shape. The middle part 16 of the front side member 10 is vulnerable to flexural deformation than the front part 12 and the rear part 14 due to characteristics of the circular arc shape. Therefore, as shown in FIG. 3, the middle part 16 may deform upward primarily, which lifts up the front part 12, and thus, safety of a passenger can be improved by effectively diminishing a sinking level when the front crash occurs.

The rear part 14 may include a rear upper part 142 provided at an upper side of the front side member 10 and a rear lower part 144 provided at a lower side of the front side member 10. Each of the rear upper part 142 and the rear lower part 144 straightly extend in the length direction of the vehicle and may incline downward toward a rear side of the vehicle.

The rear part 14 may be connected to a side sil 20 which extends along the length of the vehicle.

While this inventive concept has been described in connection with what is presently considered to be practical exemplary embodiments, it is to be understood that the inventive concept is not limited to the disclosed embodiments, but on the contrary, is intended to cover various modifications and equivalent arrangements included within the spirit and scope of the appended claims.

What is claimed is:

1. A front side member for a vehicle, comprising:
a front part mounted to a front lower right side and a front lower left side of the vehicle along a length of the vehicle;
a rear part mounted to a rear lower right side and a rear lower left side of the vehicle; and
a middle part integrally and continuously connected between the front part and rear part,
wherein the middle part includes a curved portion formed in the middle of the middle part.

2. The front side member of claim 1, wherein the front part includes:
a front upper part provided at a front upper side of the front side member and extending straightly along the length of the vehicle; and
a front lower part provided at a front lower side of the front side member and extending straightly along the length of the vehicle.

3. The front side member of claim 1, wherein the middle part includes:
a middle upper part provided at a middle upper side of the vehicle and extending straightly along the length of the vehicle; and
a middle lower part provided at a middle lower side of the vehicle,
wherein the curved portion is formed at the middle lower part.

4. The front side member of claim 1, wherein the rear part includes:
a rear upper part provided at a rear upper side of the vehicle and inclined downwards while extending straightly along the length of the vehicle; and
a rear lower part provided at a rear lower side of the vehicle and inclined downwards while extending straightly along the length of the vehicle.

5. The front side member of claim 3, wherein the middle part has an engine mount mounted thereon in front of a shock absorber position corresponding part that responds to the shock absorber position of a front suspension, and
the curved portion of the middle lower part has the center of mass located between the engine mount and the shock absorber position corresponding part.

6. The front side member of claim 1, wherein the curved portion has a circular arc shape.
